(19) United States
(12) Patent Application Publication
(10) Pub. No.: US 2015/0156303 A1
(43) Pub. Date: Jun. 4, 2015

(54) MOBILE TERMINAL AND CONTROL METHOD THEREOF

(71) Applicant: LG ELECTRONICS INC., Seoul (KR)

(72) Inventors: Dongwook SEO, Seoul (KR); Jungyub JEE, Seoul (KR)

(73) Assignee: LG ELECTRONICS INC., Seoul (KR)

(21) Appl. No.: 14/558,400

(22) Filed: Dec. 2, 2014

(30) Foreign Application Priority Data
Dec. 3, 2013 (KR) 10-2013-0149355

(51) Int. Cl. H04M 1/725; G06F 3/0488; G06F 3/0481; G06F 3/0484; G06F 3/0482

(52) U.S. Cl. CPC H04M 1/72522; G06F 3/04845; G06F 3/0482; G06F 3/04817; G06F 3/04842; G06F 3/0488

(57) ABSTRACT

An electronic device and a control method thereof are provided. The electronic device includes an interface, a display and a controller configured to display, upon connection of the electronic device to a terminal through the interface, a screen including at least one piece of content stored in a memory of the terminal on the display of the electronic device. The controller is configured to display on the screen information related to content being currently executed in the connected terminal.

### CROSS-REFERENCE TO RELATED APPLICATIONS

Pursuant to 35 U.S.C. §119(a), this application claims the benefit of earlier filing date and right of priority to Korean Patent Application No. 10-2013-0149355, filed on Dec. 3, 2013, the contents of which are incorporated by reference herein in their entirety.

### BACKGROUND OF THE INVENTION

1. Field of the Invention

The present invention relates to an electronic device and more specifically, to an electronic device capable of displaying content currently executed in a mobile terminal connected thereto and a control method thereof.

2. Discussion of the Related Art

As functions of terminals such as personal computers, laptop computers, and cellular phones diversify, the terminals have become multimedia players having multiple functions for capturing pictures or moving images, playing music, moving image files and games and receiving broadcast programs.

Terminals can be categorized as mobile terminals and stationary terminals. The mobile terminals can be further categorized as handheld terminals and vehicle mount terminals according to whether users can personally carry the terminals. Conventional terminals including mobile terminals provide an increasing number of complex and various functions.

To support and enhance the increasing number of functions in a terminal, improving a structural part and/or a software part of the terminal would be desirable.

### SUMMARY

An object of the present invention is to provide an electronic device capable of displaying content currently executed in a mobile terminal connected thereto and a control method thereof. The electronic device includes an interface, a display and a controller configured to display, upon connection of the electronic device to a terminal through the interface, a screen including at least one piece of content stored in a memory of the terminal on the display of the electronic device. The controller is configured to display on the screen information related to content being currently executed in the connected terminal.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention.

FIG. 1 is a block diagram of a mobile terminal according to an embodiment;

FIG. 2A is a front perspective view of the mobile terminal according to an embodiment;

FIG. 2B is a rear perspective view of the mobile terminal according to an embodiment;

FIG. 3 is a block diagram of an electronic device according to an embodiment of the present invention;

FIG. 4 is a flowchart illustrating an operation of the electronic device shown in FIG. 3;

FIG. 5 illustrates a connection of a mobile terminal and the electronic device shown in FIG. 3;

FIGS. 6 to 9 illustrate an operation according to connection of a terminal and the electronic device shown in FIG. 3;

FIG. 10 illustrates an operation of the electronic device shown in FIG. 3 according to another embodiment of the present invention;

FIG. 11 illustrates an operation of the electronic device shown in FIG. 3 according to another embodiment of the present invention;

FIGS. 12 to 14 illustrate an operation of the electronic device shown in FIG. 3 according to another embodiment of the present invention;

FIGS. 15 and 16 illustrate an operation of the electronic device shown in FIG. 3 according to another embodiment of the present invention;

FIGS. 17 and 18 illustrate an operation of the electronic device shown in FIG. 3 according to another embodiment of the present invention; and

FIG. 19 illustrates an operation of the electronic device shown in FIG. 3 according to another embodiment of the present invention.

### DETAILED DESCRIPTION

Arrangements and embodiments may now be described more fully with reference to the accompanying drawings, in which embodiments may be shown. Embodiments may, however, be embodied in many different forms and should not be construed as being limited to embodiments set forth herein; rather, embodiments may be provided so that this disclosure will be thorough and complete, and will fully convey the concept to those skilled in the art.

A mobile terminal may be described below with reference to the accompanying drawings. In the following description, suffixes “module” and “unit” may be given to components of the mobile terminal in consideration of only facilitation of description and do not have meanings or functions discriminated from each other.

The mobile terminal may include a cellular phone, a smart phone, a laptop computer, a digital broadcasting terminal, personal digital assistants (PDA), a portable multimedia player (PMP), a navigation system and/or so on.

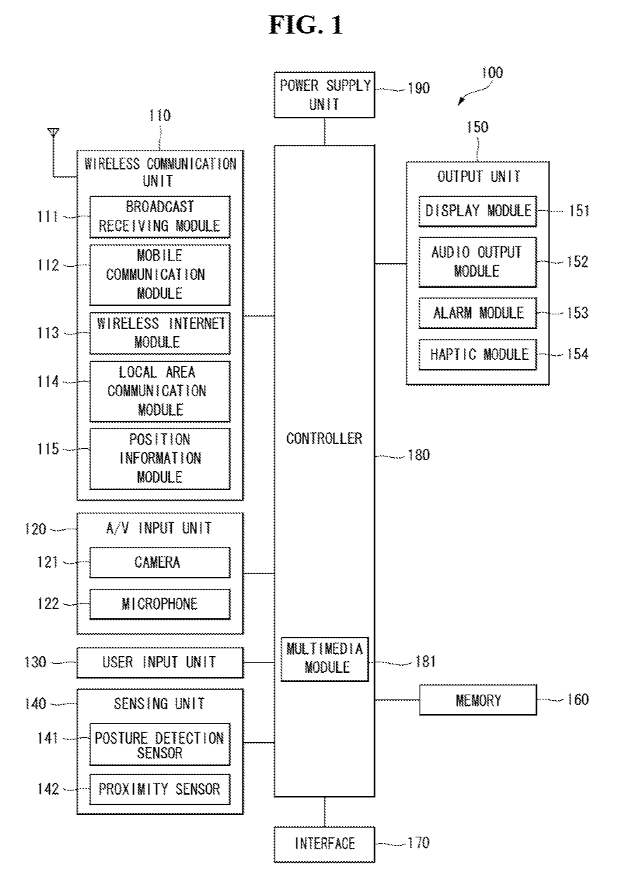

FIG. 1 is a block diagram of a mobile terminal according to an embodiment. Other embodiments, configurations and arrangements may also be provided. As shown, the mobile terminal 100 may include a wireless communication unit 110 (or radio communication unit), an audio/video (A/V) input unit 120, a user input unit 130, a sensing unit 140, an output unit 150, a memory 160, an interface 170, a controller 180, and a power supply unit 190. The components shown in FIG. 1 may be essential parts and/or a number of components included in the mobile terminal 100 may vary. Components of the mobile terminal 100 may now be described.

The wireless communication unit 110 may include at least one module that enables radio communication between the mobile terminal 100 and a radio communication system or between the mobile terminal 100 and a network in which the mobile terminal 100 is located. For example, the wireless communication unit 110 may include a broadcasting receiving module 111, a mobile communication module 112, a wireless Internet module 113, a short range communication module 114 (or local area communication module), and a location information module 115 (or position information module).

The broadcasting receiving module 111 may receive broadcasting signals and/or broadcasting related information from an external broadcasting management server through a broadcasting channel. The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal.

The broadcasting signals may include not only TV broadcasting signals, radio broadcasting signals, and data broadcasting signals but also signals in the form of a combination of a TV broadcasting signal and a radio broadcasting signal. The broadcasting related information may be information on a broadcasting channel, a broadcasting program or a broadcasting service provider, and may be provided even through a mobile communication network. In the latter case, the broadcasting related information may be received by the mobile communication module 112.

The broadcasting related information may exist in various forms. For example, the broadcasting related information may exist in the form of an electronic program guide (EPG) of a digital multimedia broadcasting (DMR) system or in the form of an electronic service guide (ESG) of a digital video broadcast-handheld (DVB-H) system.

The broadcasting receiving module 111 may receive broadcasting signals using various broadcasting systems. More particularly, the broadcasting receiving module 111 may receive digital broadcasting signals using digital broadcasting systems such as a digital multimedia broadcasting-terrestrial (DMB-T) system, a digital multimedia broadcasting-satellite (DMB-S) system, a media forward link only (MediaFLO) system, a DVB-H and integrated services digital broadcast-terrestrial (ISDB-T) systems. The broadcasting receiving module 111 may receive signals from broadcasting systems providing broadcasting signals other than the above-described digital broadcasting systems.

The broadcasting signals and/or broadcasting related information received through the broadcasting receiving module 111 may be stored in the memory 160. The mobile communication module 112 may transmit/receive a radio signal to/from at least one of a base station, an external terminal and a server on a mobile communication network. The radio signal may include a voice call signal, a video telephony call signal or data in various forms according to transmission and reception of text/multimedia messages.

The wireless Internet module 113 may correspond to a module for wireless Internet access and may be included in the mobile terminal 100 or may be externally attached to the mobile terminal 100. Wireless LAN (WLAN or Wi-Fi), wireless broadband (Wibro), world interoperability for microwave access (Wimax), high speed downlink packet access (HSDPA) and so on may be used as a wireless Internet technique.

The short range communication module 114 may correspond to a module for short range communication. Further, Bluetooth®, radio frequency identification (RFID), infrared data association (IrDA), ultra wideband (UWB) and/or ZigBee® may be used as a short range communication technique.

The location information module 115 may confirm or obtain a location or a position of the mobile terminal 100. The location information module 115 may obtain position information by using a global navigation satellite system (GNSS). The GNSS is a terminology describing a radio navigation satellite system that revolves around the earth and transmits reference signals to predetermined types of radio navigation receivers such that the radio navigation receivers can determine their positions on the earth's surface or near the earth's surface. The GNSS may include a global positioning system (GPS) of the United States, Galileo of Europe, a global orbiting navigational satellite system (GLONASS) of Russia, COMPASS of China, and a quasi-zenith satellite system (QZSS) of Japan, for example.

A global positioning system (GPS) module is a representative example of the location information module 115. The GPS module may calculate information on distances between one point or object and at least three satellites and information on a time when distance information is measured and apply trigonometry to the obtained distance information to obtain three-dimensional position information on the point or object according to latitude, longitude and altitude at a predetermined time.

A method of calculating position and time information using three satellites and correcting the calculated position and time information using another satellite may also be used. Additionally, the GPS module may continuously calculate a current position in real time and calculate velocity information using the location or position information.

The A/V input unit 120 may input (or receive) an audio signal and/or video signal. The A/V input unit 120 may include a camera 121 and a microphone 122. The camera 121 may process image frames of still images or moving images obtained by an image sensor in a video telephony mode or a photographing mode. The processed image frames may be displayed on a display 151, which may be a touchscreen.

The image frames processed by the camera 121 may be stored in the memory 160 or may be transmitted to an external device through the wireless communication unit 110. The mobile terminal 100 may also include at least two cameras 121.

The microphone 122 may receive an external audio signal in a call mode, a recording mode and/or a speech recognition mode, and the microphone 122 may process the received audio signal into electric audio data. The audio data may then be converted into a form that can be transmitted to a mobile communication base station through the mobile communication module 112 and output in the call mode. The microphone 122 may employ various noise removal algorithms (or noise canceling algorithm) for removing or reducing noise generated when the external audio signal is received.

The user input unit 130 may receive input data for controlling operation of the mobile terminal 100 from a user. The user input unit 130 may include a keypad, a dome switch, a touch pad (constant voltage/capacitance), a jog wheel, a jog switch and/or so on.

The sensing unit 140 may sense a current state of the mobile terminal 100, such as an open/close state of the mobile terminal 100, a position of the mobile terminal 100, whether a user touches the mobile terminal 100, a direction of the mobile terminal 100, and acceleration/deceleration of the mobile terminal 100, and the sensing unit 140 may generate a sensing signal for controlling operation of the mobile terminal 100. For example, in an example of a slide phone, the sensing unit 140 may sense whether the slide phone is opened or closed. Further, the sensing unit 140 may sense whether the power supply unit 190 supplies power and/or whether the interface 170 is connected to an external device. The sensing unit 140 may also include a posture detection sensor 141 for detecting a posture of the mobile terminal 100 and a proximity sensor 142. The sensing unit 140 may sense a motion of the mobile terminal 100.

The output unit 150 may generate visual, auditory and/or tactile output, and the output unit 150 may include the display 151, an audio output module 152, an alarm module 153 and a haptic module 154. The display 151 may display information processed by the mobile terminal 100. The display 151 may display a user interface (UI) and/or a graphic user interface (GUI) related to a telephone call when the mobile terminal 100 is in the call mode. The display 151 may also display a captured and/or received image, a UI or a GUI when the mobile terminal 100 is in the video telephony mode or the photographing mode.

The display 151 may include at least one of a liquid crystal display, a thin film transistor liquid crystal display, an organic light-emitting diode display, a flexible display and/or a three-dimensional display. The display 151 may be of a transparent type or a light transmissive type. That is, the display 151 may include a transparent display.

The transparent display may be a transparent liquid crystal display. A rear structure of the display 151 may also be of a light transmissive type. Accordingly, a user may see an object located behind the body (of the mobile terminal 100) through the transparent area of the body of the mobile terminal 100 that is occupied by the display 151.

The mobile terminal 100 may also include at least two displays 151. For example, the mobile terminal 100 may include a plurality of displays 151 that are arranged on a single face at a predetermined distance or integrated displays. The plurality of displays 151 may also be arranged on different sides.

When the display 151 and a sensor sensing touch (hereafter referred to as a touch sensor) form a layered structure that is referred to as a touchscreen, the display 151 may be used as an input device in addition to an output device. The touch sensor may be in the form of a touch film, a touch sheet, and/or a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 can detect a touched portion of the display 151.

The proximity sensor 142 (of the sensing unit 140) may be located in an internal region of the mobile terminal 100, surrounded by the touchscreen, and/or near the touchscreen. The proximity sensor 142 may sense an object approaching a predetermined sensing face or an object located near the proximity sensor 142 using an electromagnetic force or infrared rays without having mechanical contact. The proximity sensor 142 may have a lifetime longer than a contact sensor and may thus have a wide application in the mobile terminal 100.

The proximity sensor 142 may include a transmission type photo-electric sensor, a direct reflection type photo-electric sensor, a mirror reflection type photo-electric sensor, a high-frequency oscillating proximity sensor, a capacitive proximity sensor, a magnetic proximity sensor, and/or an infrared proximity sensor. A capacitive touchscreen may be constructed such that proximity of a pointer is detected through a variation in an electric field according to the proximity of the pointer. The touchscreen (touch sensor) may be classified as a proximity sensor 142.

For ease of explanation, an action of the pointer approaching the touchscreen without actually touching the touchscreen may be referred to as a proximity touch and an action of bringing the pointer into contact with the touchscreen may be referred to as a contact touch. The proximity touch point of the pointer on the touchscreen may correspond to a point of the touchscreen at which the pointer is perpendicular to the touchscreen.

The proximity sensor 142 may sense the proximity touch and a proximity touch pattern (e.g., a proximity touch distance, a proximity touch direction, a proximity touch velocity, a proximity touch time, a proximity touch position, a proximity touch moving state, etc.). Information corresponding to the sensed proximity touch action and proximity touch pattern may then be displayed on the touchscreen.

The audio output module 152 may output audio data received from the wireless communication unit 110 or stored in the memory 160 in a call signal receiving mode, a telephone call mode or a recording mode, a speech recognition mode and a broadcasting receiving mode. The audio output module 152 may output audio signals related to functions, such as a call signal incoming tone and a message incoming tone, performed in the mobile terminal 100. The audio output module 152 may include a receiver, a speaker, a buzzer, and/or the like. The audio output module 152 may output sounds through an earphone jack. The user may hear the sounds by connecting an earphone to the earphone jack.

The alarm module 153 may output a signal for indicating generation of an event of the mobile terminal 100. For example, an alarm may be generated when receiving a call signal, receiving a message, inputting a key signal, and/or inputting a touch. The alarm module 153 may also output signals in forms different from video signals or audio signals, for example, a signal for indicating generation of an event through vibration. The video signals and/or the audio signals may also be output through the display 151 or the audio output module 152.

The haptic module 154 may generate various haptic effects that the user can feel. One example of the haptic effects is vibration. An intensity and/or pattern of vibration generated by the haptic module 154 may also be controlled. For example, different vibrations may be combined and output or may be sequentially output.

The haptic module 154 may generate a variety of haptic effects including an effect of stimulus according to an arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 may not only transmit haptic effects through direct contact but may also allow the user to feel haptic effects through a kinesthetic sense of the user's fingers or arms. The mobile terminal 100 may also include a plurality of haptic modules 154.

The memory 160 may store a program for operations of the controller 180 and/or temporarily store input/output data such as a phone book, messages, still images, and/or moving images. The memory 160 may also store data about vibrations and sounds in various patterns that are output from when a touch input is applied to the touchscreen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk. The mobile terminal 100 may also operate in relation to a web storage that performs a storing function of the memory 160 on the Internet.

The interface 170 may serve as a path to external devices connected to the mobile terminal 100. The interface 170 may receive data from the external devices or power and transmit the data or power to internal components of the mobile terminal 100 or transmit data of the mobile terminal 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The interface 170 may also interface with a user identification module that is a chip that stores information for authenticating authority to use the mobile terminal 100. For example, the user identification module may be a user identify module (UIM), a subscriber identify module (SIM) and/or a universal subscriber identify module (USIM). An identification device (including the user identification module) may also be manufactured in the form of a smart card. Accordingly, the identification device may be connected to the mobile terminal 100 through a port of the interface 170.

The interface 170 may also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle may be used as signals for confirming whether the mobile terminal 100 is correctly set in the cradle.

The controller 180 can control overall operations of the mobile terminal 100. For example, the controller 180 can perform control and processing for voice communication, data communication and/or video telephony. The controller 180 can also include a multimedia module 181 for playing multimedia. The multimedia module 181 may be included in the controller 180 or may be separated from the controller 180.

The controller 180 can perform a pattern recognition process capable of recognizing handwriting input or picture-drawing input applied to the touchscreen as characters or images. The power supply unit 190 may receive external power and internal power and provide power required for operations of the components of the mobile terminal 100 under control of the controller 180.

According to hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. Embodiments may be implemented by the controller 180.

According to software implementation, embodiments such as procedures or functions may be implemented with a separate software module that executes at least one function or operation. Software codes may be implemented according to a software application written in an appropriate software language. The software codes may be stored in the memory 160 and executed by the controller 180.

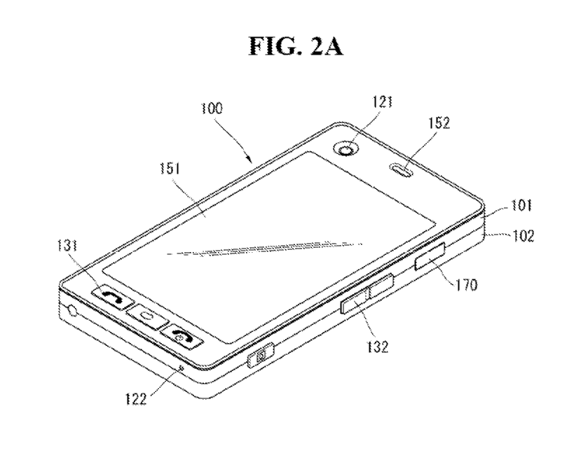

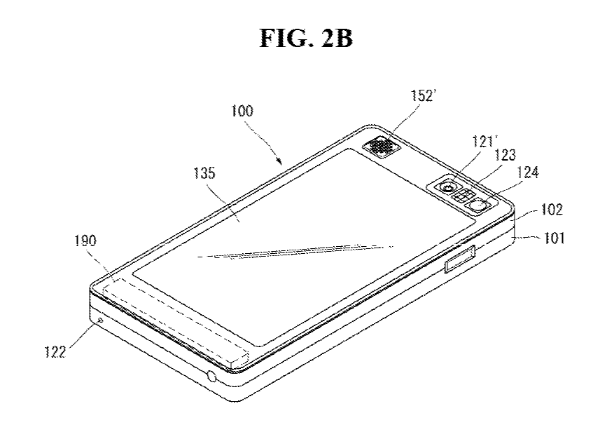

FIG. 2A is a front perspective view of a mobile terminal (or a handheld terminal) according to an embodiment. The mobile terminal 100 may be a bar type terminal body. However, embodiments are not limited to a bar type terminal and may be applied to terminals of various types including slide type, folder type, swing type and/or swivel type terminals having at least two bodies that are relatively movably combined.

The terminal body may include a case (a casing, a housing, a cover, etc.) that forms an exterior of the mobile terminal 100. In this embodiment, the case may be divided into a front case 101 and a rear case 102. Various electronic components may be arranged in the space formed between the front case 101 and the rear case 102. At least one middle case may be additionally provided between the front case 101 and the rear case 102.

The cases may be formed of plastics through injection molding or made of a metal material such as stainless steel (STS) or titanium (Ti). The display 151, the audio output unit 152, the camera 121, the user input unit 130/131 and 132, the microphone 122 and the interface 170 may be arranged (or provided) in the terminal body, and more specifically may be arranged (or provided) in the front case 101.

The display 151 may occupy most of the main face of the front case 101. The audio output unit 152 and the camera 121 may be arranged in a region in proximity to one of both ends of the display 151 and the user input unit 131, and the microphone 122 may be located in a region in proximity to another end of the display 151. The user input unit 132 and the interface 170 may be arranged (or provided) on sides of the front case 101 and the rear case 102.

The user input unit 130 may receive commands for controlling operation of the mobile terminal 100, and may include a plurality of operating units 131 and 132. The operating units 131 and 132 may be referred to as manipulating portions and may employ any tactile manner in which a user operates the operating units 131 and 132 while having tactile feeling.

The first and second operating units 131 and 132 may receive various inputs. For example, the first operating unit 131 may receive commands such as start, end and scroll and the second operating unit 132 may receive commands such as control of a volume of sound output from the audio output unit 152 or conversion of the display 151 to a touch recognition mode.

FIG. 2B is a rear perspective view of the mobile terminal according to an embodiment. Referring to FIG. 2B, a camera 121′ may be additionally attached to the rear side of the terminal body (i.e., the rear case 102). The camera 121′ may have a photographing direction opposite to that of the camera 121 and may have pixels different from those of the camera 121.

For example, it may be desirable that the camera 121 has low pixels such that the camera 121 may capture an image of a face of a user and transmit the image to a receiving part during video telephony while the camera 121′ has high pixels because the camera 121′ captures an image of a general object and does not immediately transmit the image in many cases. The cameras 121 and 121′ may be attached (or provided) to the terminal body such that the cameras 121 and 121′ may rotate or pop-up.

A flash bulb 123 and a mirror 124 may be additionally provided in proximity to the camera 121′. The flash bulb 123 may light an object when the camera 121′ takes a picture of the object. The mirror 124 may be used for the user to look at his/her face in the mirror when the user wants to self-photograph himself/herself using the camera 121′.

An audio output unit 152′ may be additionally provided on the rear side of the terminal body. The audio output unit 152′ may achieve a stereo function with the audio output unit 152 (shown in FIG. 2A) and may be used for a speaker phone mode when the terminal is used for a telephone call.

A broadcasting signal receiving antenna may be additionally attached (or provided) to the side of the terminal body in addition to an antenna for telephone calls. The antenna constructing a part of the broadcasting receiving module 111 (shown in FIG. 1) may be set in the terminal body such that the antenna may be pulled out of the terminal body.

The power supply unit 190 for providing power to the mobile terminal 100 may be set in the terminal body. The power supply unit 190 may be included in the terminal body or may be detachably attached to the terminal body.

A touch pad 135 for sensing touch may be attached to the rear case 102. The touch pad 135 may be of a light transmission type, such as the display 151. In this example, if the display 151 outputs visual information through both sides thereof, the visual information may be recognized (or determined) by the touch pad 135. The information output through both sides of the display 151 may be controlled by the touch pad 135. Otherwise, a display may be additionally attached (or provided) to the touch pad 135 such that a touchscreen may be arranged (or provided) even in the rear case 102.

The touch pad 135 may operate in connection with the display 151 of the front case 101. The touch pad 135 may be located in parallel with the display 151 behind the display 151. The touch panel 135 may be identical to or smaller than the display 151 in size.

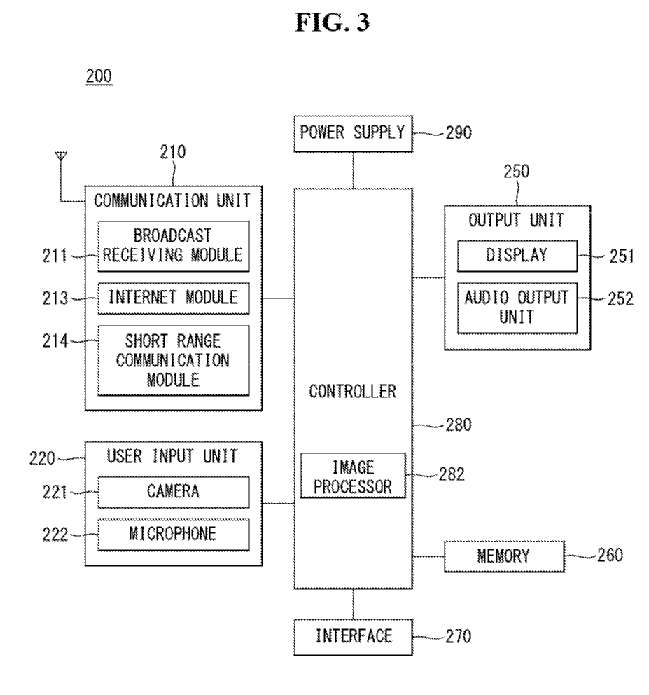

FIG. 3 is a block diagram of an electronic device according to an embodiment of the present invention. As shown, the electronic device 200 according to an embodiment of the present invention may include a communication unit 210, a user input unit 220, an output unit 250, a memory 260, an interface 270, a controller 280 and a power supply 290. The components shown in FIG. 3 are normal components that may be included in a display. Accordingly, a display including a larger or smaller number of components than the components shown in FIG. 3 may be implemented.

The communication unit 210 may include one or more modules that enable communication between the electronic device 200 and a communication system or between the electronic device 200 and another device. For example, the communication unit 210 may include a broadcast receiving module 211, an Internet module 213 and a short range communication module 214.

The broadcasting receiving module 111 may receive broadcast signals and/or broadcast related information from an external broadcast management server through a broadcast channel.

The broadcast channel may include a satellite channel and a terrestrial channel. The broadcast management server may be a server that generates and transmits broadcast signals and/or broadcast related information or a server that receives previously created broadcast signals and/or broadcast related information and transmits the broadcast signals and/or broadcast related information to a terminal. The broadcast signals may include not only TV broadcast signals, radio broadcast signals, and data broadcast signals but also signals in the form of a combination of a TV broadcast signal and a radio broadcast signal.

The broadcast related information may be information on a broadcast channel, a broadcast program or a broadcast service provider, and may be provided even through a communication network.

The broadcast related information may exist in various forms. For example, the broadcast related information may exist in the form of an electronic program guide (EPG) of a digital multimedia broadcasting (DMB) system or in the form of an electronic service guide (ESG) of a digital video broadcast-handheld (DVB-H) system.

The broadcast receiving module 211 may receive broadcast signals using various broadcasting systems. Broadcast signals and/or broadcast related information, received through the broadcast receiving module 211, may be stored in the memory 260.

The Internet module 213 may correspond to a module for Internet access and may be included in the electronic device 200 or may be externally attached to the electronic device 200.

The short range communication module 214 may correspond to a module for short range communication. Further, Bluetooth®, radio frequency identification (RFID), infrared data association (IrDA), ultra wideband (UWB) and/or ZigBee® may be used as a short range communication technique.

The user input unit 220 is used to receive audio signals or video signals and may include a camera 221, a microphone 22, etc.

The camera 221 may process image frames of still images or moving images obtained by an image sensor in a video telephony mode or a photographing mode. The processed image frames may be displayed on a display 251. The camera 221 may be a 2D or 3D camera, or a combination of 2D and 3D cameras.

The image frames processed by the camera 221 may be stored in the memory 260 or may be transmitted to an external device through the communication unit 210. The electronic device 200 may include at least two cameras 221.

The microphone 222 may receive an external audio signal in a call mode, a recording mode and/or a speech recognition mode, and the microphone 222 may process the received audio signal into electrical audio data. The microphone 122 may employ various noise removal algorithms for removing or reducing noise generated when the external audio signal is received.

The output unit 250 may include the display 251, an audio output unit 252, etc. The display 251 may display information processed by the electronic device 200. The display 151 may display a user interface (UI) and/or a graphical user interface (GUI) related to the electronic device 200. The display 251 may include at least one of a liquid crystal display, a thin film transistor liquid crystal display, an organic light-emitting diode display, a flexible display and/or a three-dimensional display. The display 251 may be of a transparent type or a light transmissive type. That is, the display 251 may include a transparent display. The transparent display may be a transparent liquid crystal display. A rear structure of the display 251 may also be of a light transmissive type. Accordingly, a user may see an object located behind the body of the electronic device 200 through the transparent area of the body that is occupied by the display 251.

The electronic device 200 may include at least two displays 251. For example, the electronic device 200 may include a plurality of displays 251 that are arranged on a single face at a predetermined distance or integrated displays. The plurality of displays 251 may also be arranged on different sides.

When the display 251 and a sensor sensing touch (hereafter referred to as a touch sensor) form a layered structure (which is referred to as a touchscreen), the display 251 may be used as an input device in addition to an output device. The touch sensor may be in the form of a touch film, a touch sheet, and/or a touch pad, for example.

The touch sensor may convert variation in pressure applied to a specific portion of the display 251 or variation in capacitance generated at a specific portion of the display 251 into an electrical input signal. The touch sensor may sense pressure of touch as well as position and area of the touch.

When the user applies touch input to the touch sensor, a signal corresponding to the touch input may be transmitted to a touch controller. The touch controller may then process the signal and transmit data corresponding to the processed signal to the controller 280. Accordingly, the controller 280 may detect a touched portion of the display 251.

The audio output module 252 may output audio data received from the communication unit 210 or stored in the memory 260. The audio output module 252 may output audio signals related to functions (such as a call signal incoming tone and a message incoming tone) performed in the electronic device 200. The audio output module 252 may include a receiver, a speaker, a buzzer, and the like.

The memory 260 may store a program for operations of the controller 280 and/or temporarily store input/output data (such as a phone book, messages, still images, and/or moving images). The memory 260 may also store data about vibrations and sounds in various patterns that are output when touch input is applied to the touchscreen.

The memory 260 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk. The electronic device 200 may also operate in relation to a web storage that performs a storage function of the memory 260 over the Internet.

The interface 270 may serve as a path to external devices connected to the electronic device 200. The interface 270 may receive data or power from the external devices and transmit the data or power to internal components of the electronic device 200 or transmit data of the electronic device 200 to the external devices. For example, the interface 270 may include a wired/wireless headset port, an external charger port, a wired/wireless data port, a memory card port, a port for connecting a device having a user identification module, an audio I/O port, a video I/O port, and/or an earphone port.

The controller 280 may control overall operations of the electronic device 200. For example, the controller 280 may perform control and processing for voice communication, data communication and/or video telephony. The controller 280 may include an image processor 282 for image processing.

The power supply 290 may receive external power and internal power and provide power required for operations of the components of the electronic device 200 under control of the controller 280.

Embodiments described hereinafter may be implemented in a recording medium readable by a computer or similar devices using hardware, software, or a combination thereof. According to a hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. Embodiments may be implemented by the controller 280.

According to software implementation, embodiments such as procedures or functions may be implemented with a separate software module that executes at least one function or operation. Software code may be implemented according to a software application written in an appropriate language. The software codes may be stored in the memory 160 and executed by the controller 180.

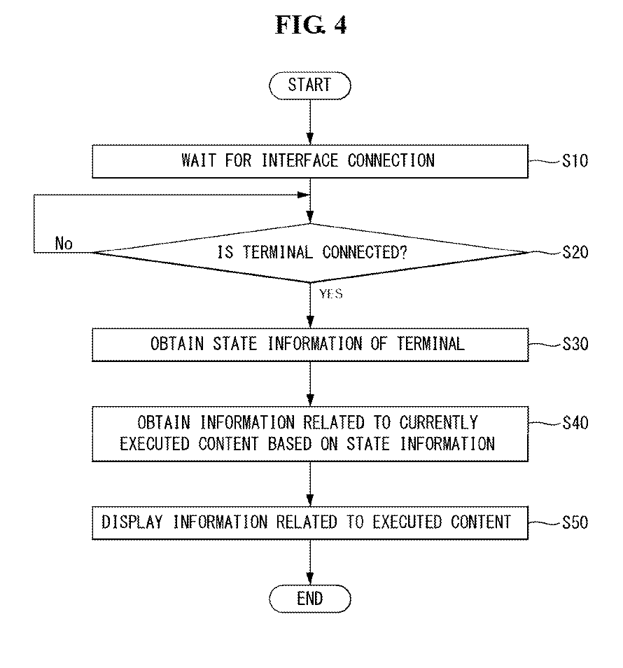

FIG. 4 is a flowchart illustrating an operation of the electronic device shown in FIG. 3. As shown, the controller 280 of the electronic device 200 according to an embodiment of the present invention waits for interface connection (S10).

The electronic device 200 may be connected to another device such as a terminal through the interface unit 270. The interface 270 may be a physical connection port provided to a specific portion of the electronic device 200 or the interface 270 may be the communication unit 210 used for wireless communication with the other device. That is, the interface 270 may be a structure for connecting the electronic device 200 and the other device such that the electronic device 200 and the other device can exchange data irrespective of configuration thereof.

The interface 270 may operate according to USB protocol and/or MTP (media transfer protocol). When the interface 270 operates according to MTP, access of stored content may be restricted using a password or the like.

The controller 280 may obtain state information of the terminal 100 (S30) upon connection of the electronic device 200 and the terminal 100 through the interface 270 in step S20. The state information of the terminal 100 may be data about the current state of the terminal 100. For example, the state information may be at least one of the type of an application currently executed in the terminal 100, the current state of the application, the type of content displayed through the terminal, state of the displayed content and data of the displayed content.

The controller 280 may obtain information related to currently executed content based on the state information (S40). As noted above, the state information may include information about content currently executed in the terminal 100. For example, when a specific image of an image gallery is displayed on the display 151 of the terminal 100, the display state may be the state information. Alternatively, the state information may include information about an application currently executed in the terminal 100. For example, when a specific image is displayed on the display 151 through an image viewer application, information about the image viewer application may be the state information.

When the terminal 100 and the electronic device 200 are connected through the interface 270, the electronic device 200 can obtain predetermined data from the terminal 100. The controller 280 can obtain information about currently executed content based on the information obtained from the terminal 100. For example, upon determining that the terminal 100 currently displays a specific image based on the state information, the controller 280 can obtain the specific image. In addition, upon determining that the terminal 100 currently executes a specific application based on the state information, the controller 280 can obtain data related to execution of the specific application.

The controller 280 displays the information related to the currently executed content (S50). As described above, the currently executed content may be content executed in the terminal 100. Alternatively, the currently executed content may be content currently displayed on the display 151 of the terminal 100.

The controller 280 can display information about content being executed in the terminal 100. That is, the controller 280 can display, on the display 251 of the electronic device 200, the content currently executed in the terminal 100 based on the information obtained from the terminal 100 connected to the electronic device 200 through the interface 270.

When the content currently executed or displayed through the terminal 100 is displayed on the display 251 of the electronic device 200 connected to the terminal 100, the user can enjoy the content through the relatively larger display 251 of the electronic device 200. That is, the content is displayed on the display 251 of the electronic device 200 simply by connecting the electronic device 200 to the terminal 100 without additional operation, and thus convenience of use is improved. Considering that only an explorer is displayed when the terminal 100 is connected to a PC and thus the user needs to perform additional manipulation in order to view content stored in the terminal 100 through the PC in the conventional method, the present invention can improve user convenience. That is, when various folders such as images, videos, texts and the like are present in the memory 160 of the terminal 100, it is difficult for the user to find a folder in which data related to currently displayed content is located. Accordingly, the present invention is advantageous over the related art method.

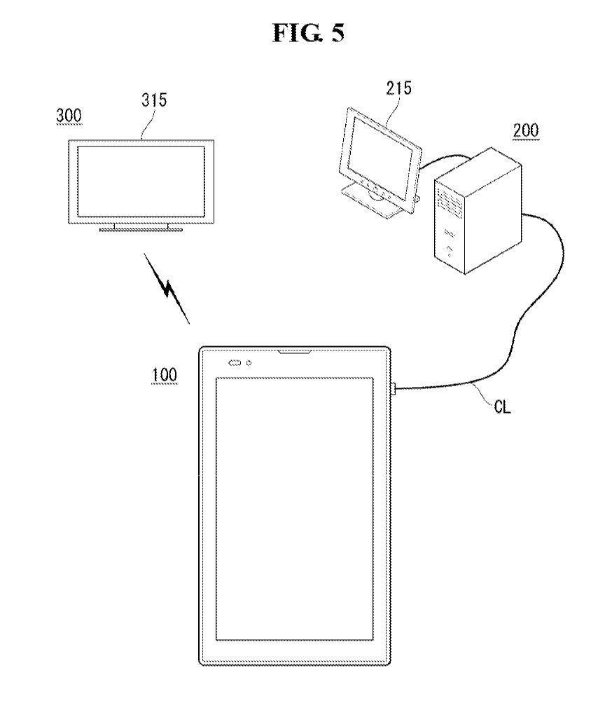

FIG. 5 illustrates interconnection of the electronic device shown in FIG. 3 and a mobile terminal. As shown, electronic devices 200 and 300 according to an embodiment of the present invention may be connected to the terminal 100. The electronic devices 200 and 300 may be any of a mobile terminal and a stationary terminal. For example, the mobile terminal may be a notebook computer, tablet PC, smart pad or the like and the stationery terminal may be a desktop PC, TV receiver, etc. However, for purposes of explanation only, the electronic devices 200 and 300 will be described as stationary terminals in the following description.

The electronic devices 200 and 300 may be connected to the terminal 100 in various manners. For example, the first electronic device 200 may be connected to the terminal 100 through a cable CL and the second electronic device 300 may be wirelessly connected to the terminal 100. The first and second electronic devices 200 and 300 may be connected to the terminal 100 simultaneously or selectively. Upon connection to the terminal 100 through the cable CL, the first electronic device 200 may obtain content currently displayed through the terminal 100 and display the obtained content. Upon wireless connection to the terminal 100, the second electronic device 300 may obtain and display content displayed through the terminal 100.

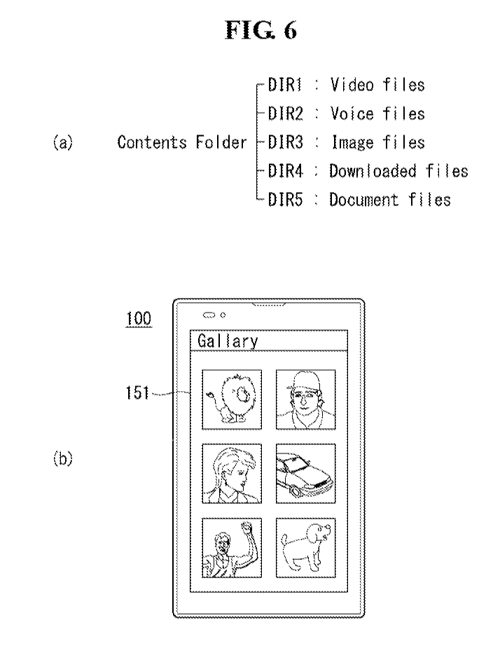

FIGS. 6 to 9 illustrate an operation according to connection of the electronic device shown in FIG. 3 and the terminal. As shown, the electronic device 200 according to an embodiment of the present invention may display content obtained through connection to the terminal 100.

Referring to FIG. 6(a), various types of content may be stored in the memory 160 of the terminal 100. For example, video content, voice content, image content, downloaded content, document content and the like can be stored in the memory 160.

The content may be stored according to attributes thereof. For example, the content may be stored in different folders according to attributes thereof. The number of folders storing content may increase as the number of uses of the terminal 100 increases. For example, when an application is installed, a folder for the application may be newly generated.

Folders may have various names. For some applications it may be difficult to guess content stored in a folder using the name of the folder. Accordingly, in some situations, the user needs to select the folders to check the files stored in each folder to find desired content.

Referring to FIG. 6(b), specific content selected by the user and/or the controller 180 can be displayed on the display 151 of the terminal 100. For example, a specific image gallery selected by the user may be displayed on the display 151.

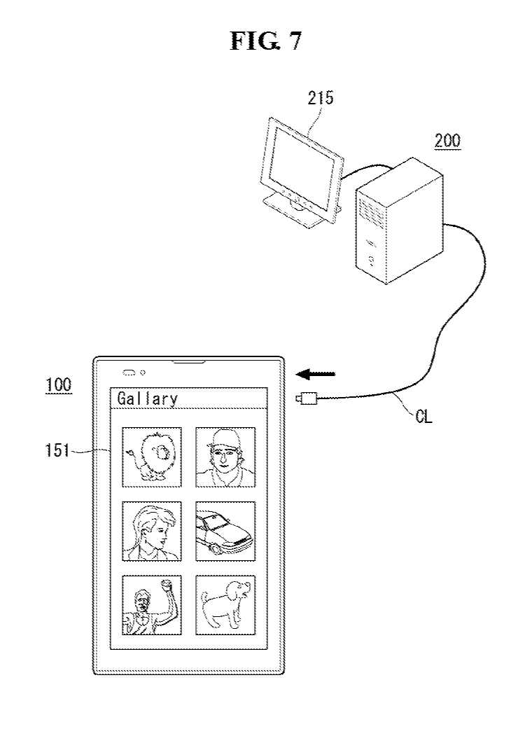

Referring to FIG. 7, the user may connect the terminal 100 to the electronic device 200. The terminal 100 and the electronic device 200 may be connected through the cable CL. That is, the interfaces of the two devices can be electrically connected through the cable CL.

Specific content selected by the user and/or the controller 180 can be displayed on the display 151 of the terminal 100 upon connection of the terminal 100 to the electronic device 200. For example, content of a specific folder may be displayed on the display 151.

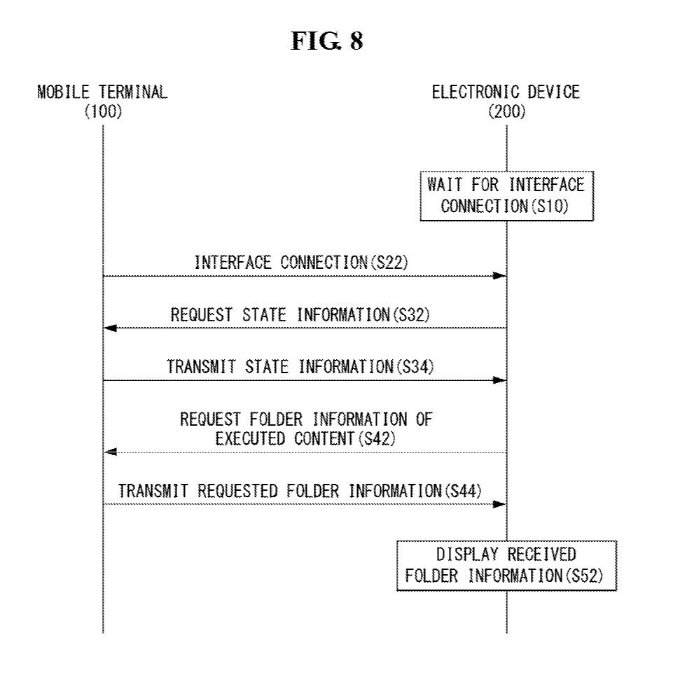

Referring to FIG. 8, the electronic device 200 may wait for interface connection (S10). That is, the electronic device 200 may wait for a situation in which the terminal 100 is connected to the electronic device 200 in a wired and/or wireless manner and thus data can be exchanged therebetween.

Upon connection of the interfaces of the terminal 100 and the electronic device 200 (S22), the electronic device 200 may request the terminal 100 to provide state information (S32). That is, the electronic device 200 may request the terminal 100 to provide data about the current state of the terminal 100.

The terminal 100 may transmit the state information to the electronic device 200 (S34). Upon reception of the state information, the electronic device 200 may request the terminal 100 to provide more detailed information. For example, the electronic device 200 may request the terminal 100 to provide folder information related to currently executed content (S42). That is, the electronic device 200 can request information about a folder, which is currently accessed, from among various folders and/or information about an accessed file of the folder. The terminal 100 may transmit the requested folder information (S44).

The electronic device 200 may display the received folder information (S52). That is, the electronic device 200 can display the content currently displayed by the terminal 100. Accordingly, the user need not repeatedly search the electronic device 200 for the corresponding content.

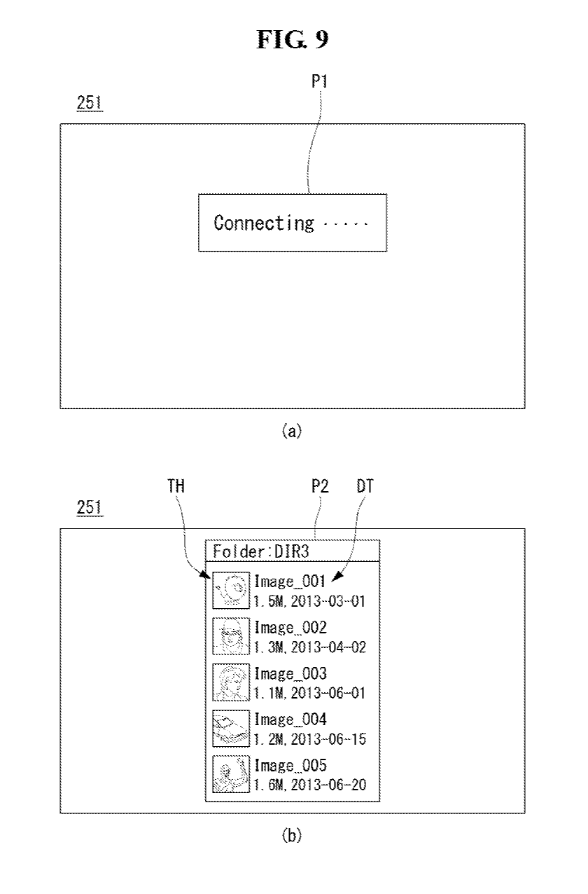

Referring to FIG. 9(a), a first pop-up window P1 indicating that the electronic device 200 is connecting to the terminal 100 through the interface may be displayed on the display 251 of the electronic device 200.

Referring to FIG. 9(b), a second pop-up window P2 may be displayed on the display 251 of the electronic device 200. The second pop-up window P2 may display information about content obtained from the terminal 100. That is, content being executed in the terminal 100 may be displayed simply through the operation of connecting the electronic device 200 and the terminal 100 even when the user does not perform an additional operation.

The second pop-up window P2 may display detailed information including thumbnails TH. That is, the second pop-up window P2 may display data about the content currently displayed through the terminal 100 and/or information about related data. For example, when the terminal 100 displays an image gallery, the second pop-up window P2 can display thumbnails TH related to the image gallery displayed on the terminal 100 and/or detailed information about images. In addition, the controller 280 may display position information about a folder in which a corresponding image is located to aid in understanding of the user.

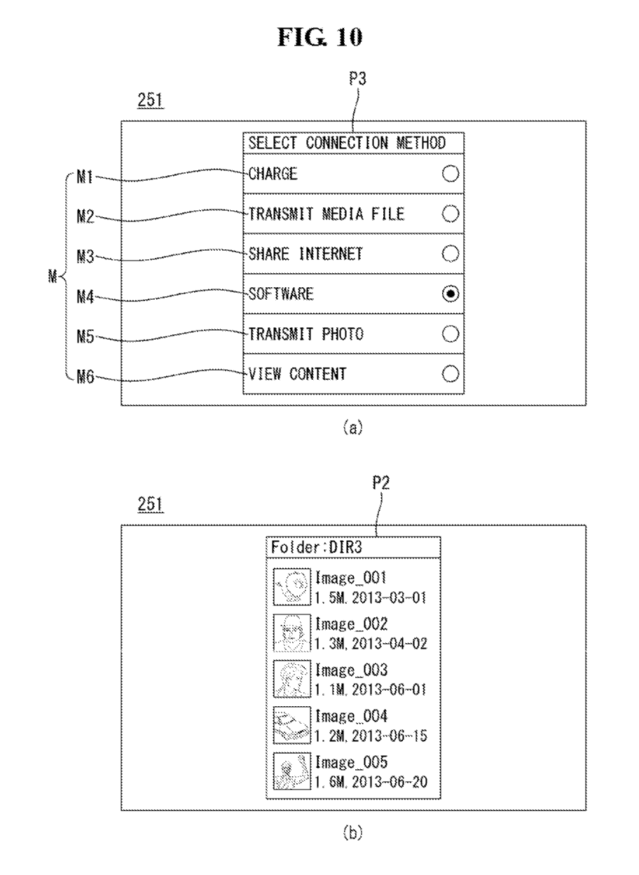

FIG. 10 illustrates an operation of the electronic device shown in FIG. 3 according to another embodiment of the present invention. As shown, the controller 280 of the electronic device 200 according to another embodiment of the present invention may add an option of directly accessing content of the terminal 100 as a menu displayed during connection of the terminal 100 to the electronic device 200.

Referring to FIG. 10(a), the controller 280 of the electronic device 200 can display a third pop-up window P3 upon connection of the electronic device 200 to the terminal 100. The controller 280 can display related menus M in the third pop-up window P3. For example, the controller 280 can display a first menu M1 providing a charging function with respect to the terminal 100, a second menu M2 providing a media file transmission function, a third menu M3 providing an Internet tethering function, a fourth menu M4 providing a specific software execution function, and a fifth menu M5 providing a photo transmission function.

Additionally, the controller 280 can display a sixth menu M6 providing a content view function through which content of the terminal 100 can be viewed through the electronic device 200. That is the content displayed on the terminal 100 may be displayed on the electronic device 200 when the corresponding function is selected by the user. Accordingly, a function according to an embodiment of the present invention can be provided such that the function is compatible with existing functions.

Referring to FIG. 10(b), upon selection of the sixth menu M6, the controller 280 may display the second pop-up window P2. That is, the content currently executed and/or displayed by the terminal 100 and/or information related to the content can be displayed.

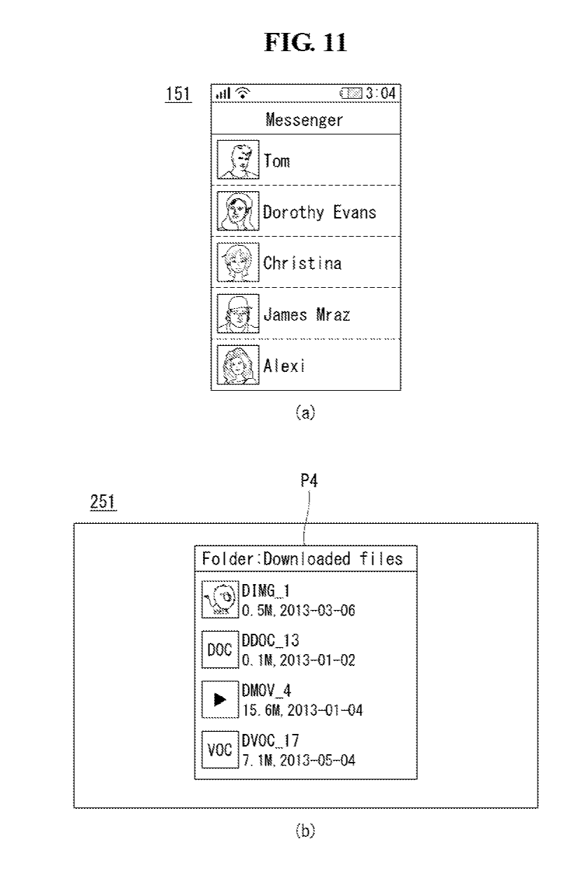

FIG. 11 illustrates an operation of the electronic device shown in FIG. 3 according to another embodiment of the present invention. As shown, the controller 280 of the electronic device 200 according to another embodiment of the present invention may display content related to a specific application currently executed in the terminal 100.

Referring to FIG. 11(a), a specific application may be executed through the display 151 of the terminal 100. For example, a messenger application can be executed. The user of the terminal 100 may connect the terminal 100 and the electronic device 200 in a wired or wireless manner while the specific application is executed.

Referring to FIG. 11(b), upon connection of the terminal 100 and the electronic device 200, the controller 280 of the electronic device 200 may display a fourth pop-up window P4. The fourth pop-up window P4 may display content related to the specific application currently executed in the terminal 100 and/or information related to the content.

The controller 280 can display information related to the application currently executed in the terminal 100. That is, content related to the application executed in the terminal 100 can be displayed upon connection of the terminal 100 to the electronic device 200. For example, when the terminal 100 executes the messenger application, the controller 280 can display files in a folder in which a file downloaded through the messenger application is located. Accordingly, the user of the terminal 100 need not additionally search for content related to an executed application in which the user is interested after connection of the terminal 100 and the electronic device 200. Considering that operations become complicated when a plurality of folders and/or files are stored in the memory 160 of the terminal 100, direct display of content related to an application executed in the terminal 100 can improve user convenience.

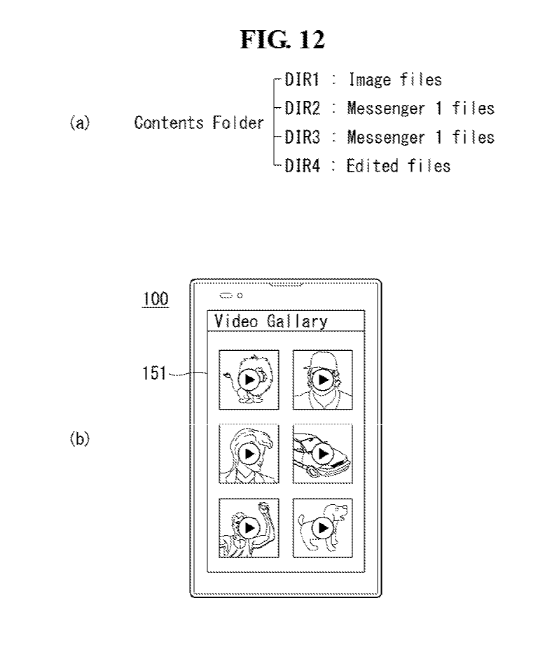

FIGS. 12 to 14 illustrate an operation of the electronic device shown in FIG. 3 according to another embodiment of the present invention. As shown, the controller 280 of the electronic device 200 according to another embodiment of the present invention may sort content based on attributes thereof even when the content is present in different positions.

Referring to FIG. 12(a), content may be stored in the memory 160 of the terminal 100. The content can be stored according to various standards. For example, the content can be sorted into image files, messenger down tiles, edited files and the like. Referring to FIG. 12(b), the display 151 of the terminal 100 can display video content from among the stored files. That is, the video content may be selected by the user and/or the controller 180.

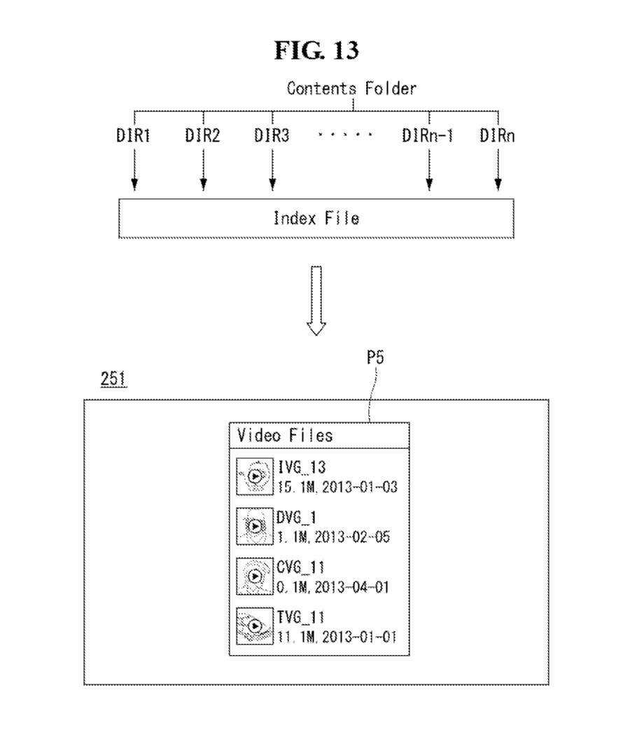

Referring to FIG. 13, various types of content may be distributed in a plurality of folders and stored in the memory 160 of the terminal 100. The controller 180 can generate an index file with respect to the content stored in the terminal 100.

The index file may include information about attributes, positions, etc. of stored files. Upon generation of the index file, each content file can be accessed through access of the index file instead of access of each content file. File access speed can be improved by accessing each file through the index file including information about the position and attribute of each file.

The index file may store information about all content files stored in the memory 160 of the terminal 100. This is different from the conventional computer in which an index file is generated for only some files or the index file is not generated. Since the terminal 100 has relatively small memory capacity and stores a relatively small amount of content, all files stored in the terminal 100 may be indexed.

The controller 280 of the electronic device 200 can rapidly access content stored in the memory 160 of the terminal 100 through the index file. That is, the controller 280 can rapidly display content currently executed in the terminal 100 by accessing the index file stored in the terminal 100.

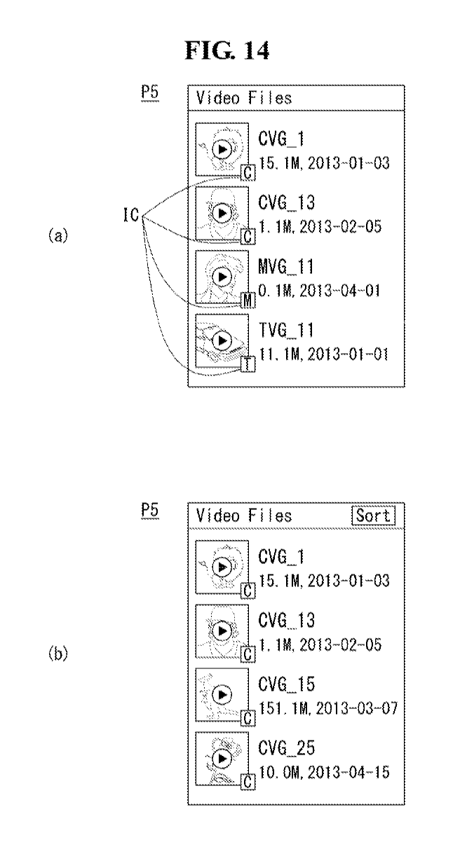

Referring to FIG. 14(a), the controller 280 of the electronic device 200 may display a fifth pop-up window P5. The fifth pop-up window P5 may display files of the terminal 100 sorted by attributes thereof. The controller 280 may add an icon IC to an obtained file to indicate an application and/or a folder related to the file. For example, icons IC such as “C”, “M” and “T”, etc. may be provided. The user can intuitively recognize content and/or folders related to the corresponding content simply by viewing the displayed icons IC.

Referring to FIG. 14(b), the filth pop-up window P5 may display a sorting button SB. Upon input of a control signal of the user and/or the controller 280, displayed content may be sorted based on attributes thereof and displayed. For example, only content corresponding to icon IC “C” can be selectively displayed.

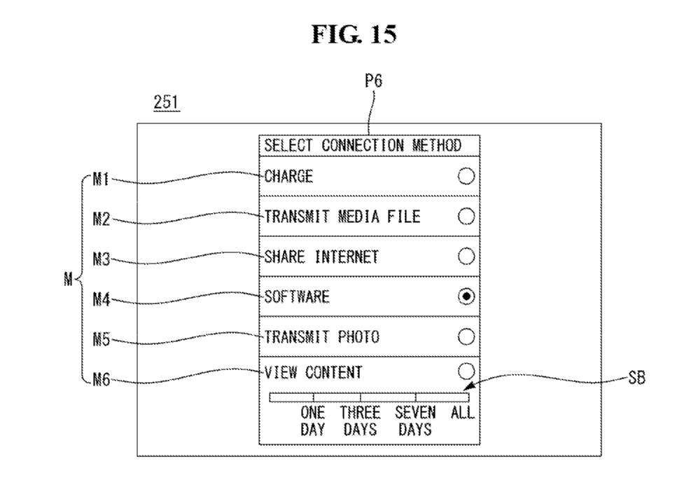

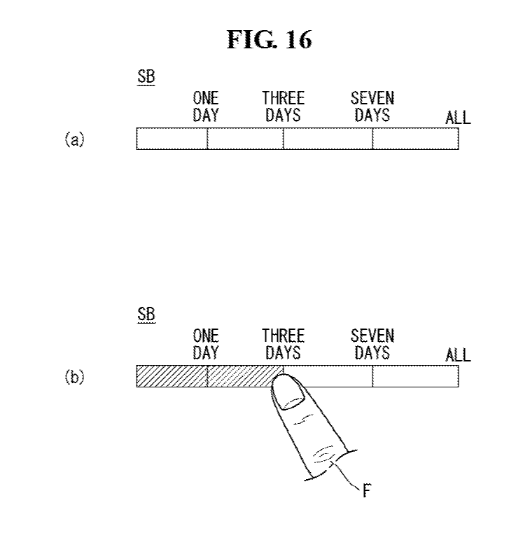

FIGS. 15 and 16 illustrate an operation of the electronic, device shown in FIG. 3 according to another embodiment of the present invention. As shown, the controller 280 of the electronic device 200 according to another embodiment of the present invention may display content intervals.

Referring to FIG. 15, the controller 280 can display a sixth pop-up window P6. The sixth pop-up window P6 may display the related menus including the sixth menu M6 providing the content view function. An interval selection bar SB may be displayed on the sixth menu M6.

The interval selection bar SB may be used to set a range of content to be displayed on the display 251 of the electronic device 200. For example, the interval selection bar SB is used to selectively display only content within a predetermined range from a corresponding time based on at least one of content generation time, content download time and recent access time. That is, the controller 280 may selectively search for only content corresponding to a selected interval and display the content.

Referring to FIG. 16(a), the interval selection bar SB may be displayed prior to an applied input. Referring to FIG. 16(b), the user may touch a specific point of the interval selection bar SB with a finger F. For example, the user can select a point indicating “three days and when “three days” is selected, only content generated during the past three days can be selectively displayed.

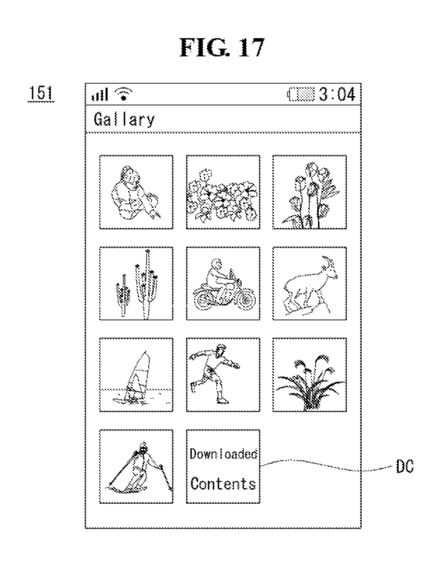

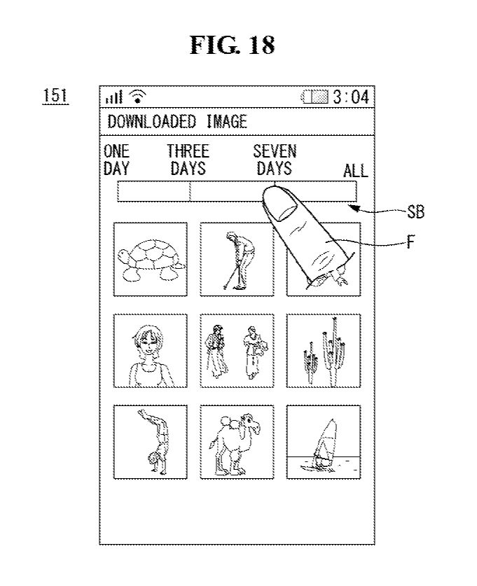

FIGS. 17 and 18 illustrate an operation of the electronic device shown in FIG. 3 according to another embodiment of the present invention. As shown, the controller 180 of the terminal 100 according to another embodiment of the present invention may manage content according to attributes thereof.

Referring to FIG. 17, the controller 180 can separately provide a downloaded content folder DC. That is the controller 180 can additionally generate a folder in which obtained content can be selectively collected. Content can be managed easily and conveniently by generating a folder for selectively storing only obtained content.

Referring to FIG. 18, the controller 180 of the terminal 100 can display the interval selection bar SB. The interval selection bar SB may be used to set a range of content to be displayed on the display 151. For example, upon input of touch of dragging the interval selection bar SB, the controller 180 can display content corresponding to a selected interval.

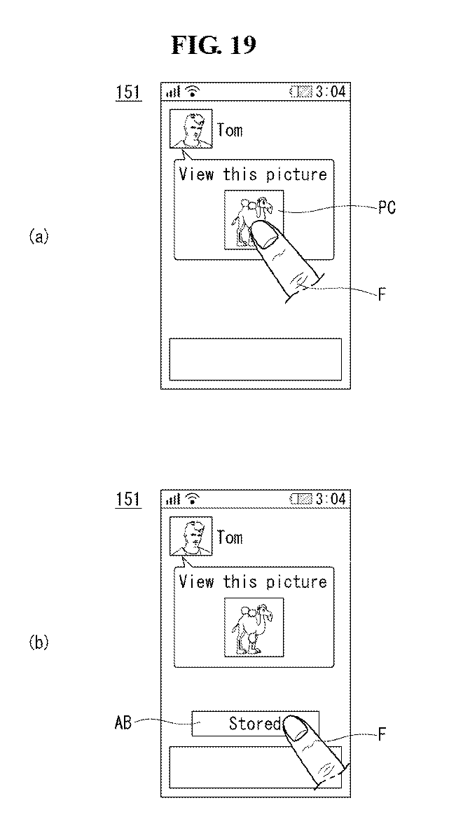

FIG. 19 illustrates an operation of the electronic device shown in FIG. 3 according to another embodiment of the present invention. As shown, the controller 180 of the terminal 100 according to another embodiment of the present invention may perform an operation corresponding to user touch applied during a procedure of storing content.

Referring to FIG. 19(a), the user may select content PC with a finger F. For example, the user can obtain image content PC from a person while chatting with the person using the messenger application.

Referring to FIG. 19(b), an information window AB may be displayed when the user touches the content PC. For example, the information window AB which indicates that the selected content PC has been stored in the memory 160 can be displayed. The information window AB may disappear after lapse of a predetermined time. Otherwise, the information window AB may be continuously displayed.

Upon selection of the information window AB, the controller 180 can display contents of a folder in which the content PC is stored on the display 151. That is, it is possible to easily search for the location of the content PC without terminating the currently executed application and additionally executing a search application and/or an image viewer application.

Upon selection of the information window AB, the controller 180 can display the content PC on the display 251 of the electronic device 200. That is, the content PC can be displayed through the electronic device 20( )having a larger display than the terminal 100.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, and optical data storage devices. The computer readable recording medium may also be distributed over network coupled computer systems so that the computer readable code is stored and executed in a distributed fashion.

A mobile terminal may include a first touchscreen configured to display a first object, a second touchscreen configured to display a second object, and a controller configured to receive a first touch input applied to the first object and to link the first object to a function corresponding to the second object when receiving a second touch input applied to the second object while the first touch input is maintained.

A method may be provided of controlling a mobile terminal that includes displaying a first object on the first touchscreen, displaying a second object on the second touchscreen, receiving a first touch input applied to the first object, and linking the first object to a function corresponding to the second object when a second touch input applied to the second object is received while the first touch input is maintained.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the invention, the drawings and the appended claims. In addition to variations and modifications in the component parts and/or arrangements, alternative uses will also be apparent to those skilled in the art.

What is claimed is:

1. An electronic device, comprising:
an interface;
a display; and
a controller configured to:
display, upon connection of the electronic device to a terminal through the interface, a screen including at least one piece of content stored in a memory of the terminal on the display of the electronic device, and
display on the screen information related to content being currently executed in the connected terminal.

2. The electronic device of claim 1, wherein the controller is configured to acquire state information of the connected terminal and to obtain and display information related to the currently executed content based on the acquired state information.

3. The electronic device of claim 1, wherein the information related to the currently executed content includes information about a folder storing the currently executed content from among a plurality of folders stored in the memory of the terminal.

4. The electronic device of claim 1, wherein the currently executed content corresponds to at least one of image content, video content or document content, and the at least one piece of content includes the at least one piece of content.

5. The electronic device of claim 1, wherein, upon connection of the electronic device and the terminal, the controller is configured to display on the display a pop-up window through which a user manipulation signal is applied to the connected terminal, and
wherein the pop-up window displays a menu for displaying information related to the currently executed content.

6. The electronic device of claim 5, wherein the controller is configured to obtain information related to the currently executed content and to display the information on the display upon acquisition of a selection signal of the user applied to the displayed menu.

7. The electronic device of claim 1, wherein the controller is configured to obtain the information related to the currently executed content from an index file identifying content stored in the terminal.

8. The electronic device of claim 1, wherein the information related to the currently executed content includes attribute information of the currently executed content, and
wherein the controller is configured to align and display the information related to the currently executed content based on the attribute information.

9. The electronic device of claim 8, wherein the controller is configured to add an icon to the displayed information based on the attribute information.

10. The electronic device of claim 9, wherein the displayed information is sortable based on the icon added to the displayed information.

11. The electronic device of claim 1, wherein the controller is configured to display the information related to the currently executed content corresponding to a variable display range.

12. The electronic device of claim 11, wherein the controller is configured to display at least one selection bar through which user input to the at least one selection bar changes the variable display range.

13. The electronic device of claim 1, wherein the currently executed content is an application being currently executed in the terminal.

14. A method for controlling an electronic device, the method comprising:
connecting the electronic device to a terminal through an interface;
obtaining, via a controller of the electric device, state information of the terminal, and
displaying on a display of the electronic device information related to content currently executed in the connected terminal based on the obtained state information.

15. The method of claim 14, wherein obtaining state information comprises obtaining information about a folder storing the currently executed content from among a plurality of folders stored in a memory of the terminal.

16. The method of claim 14, further comprising, upon connection of the electronic device and the terminal, displaying on the display a pop-up window through which a manipulation signal of a user is applied to the connected terminal; and
displaying on the pop-up window a menu for displaying information related to the currently executed content.

17. The method of claim 14, wherein the obtaining of the state information comprises obtaining the information related to the currently executed content from an index file identifying content stored in the terminal.

18. The method of claim 14, wherein the displaying of the information related to content currently executed in the connected terminal comprises displaying the information related to the currently executed content corresponding to a variable display range.

19. The method of claim 18, wherein the displaying of the information related to content currently executed in the connected terminal comprises displaying at least one selection bar through which user input to the at least one selection bar changes the variable display range.

20. The method of claim 14, wherein the currently executed content corresponds to at least one of image content, video content, document content or an application being currently executed in the terminal.
